(19) United States
(12) Patent Application Publication
(10) Pub. No.: US 2026/0037465 A1
(43) Pub. Date: Feb. 5, 2026

(54) UNIFIED BUFFER MANAGEMENT IN DATABASE MANAGEMENT SYSTEMS

(71) Applicant: Actian Corporation, Round Rock, TX (US)

(72) Inventors: Steffen KLÄBE, Ilmenau (DE); Stephan BAUMANN, Ilmenau (DE); Alexander BAUMSTARK, Erfurt (DE); Kai-Uwe SATTLER, Ilmenau (DE)

(21) Appl. No.: 19/285,341

(22) Filed: Jul. 30, 2025

Related U.S. Application Data
(60) Provisional application No. 63/678,495, filed on Aug. 1, 2024.

(51) Int. Cl. G06F 13/28; G06F 13/42; G06F 16/25

(52) U.S. Cl. CPC G06F 13/28; G06F 13/4282; G06F 16/252; G06F 2213/0026

(57) ABSTRACT

Aspects described herein relate to accessing, by a compute node of a database management system (DBMS), one or more objects in state information for a database in a unified memory architecture having multiple memory nodes, such as compute express link (CXL), where the accessing includes using direct memory access (DMA) to access memory in at least a portion of the multiple memory nodes, and performing, by the compute node, one or more query operations for the database based on the state information.

### CLAIM OF PRIORITY UNDER 35 U.S.C. § 119

The present Application for Patent claims priority to Provisional Patent Application No. 63/678,495, entitled “UNIFIED BUFFER MANAGEMENT IN DATABASE MANAGEMENT SYSTEMS” filed Aug. 1, 2024, which is assigned to the assignee hereof and hereby expressly incorporated by reference herein for all purposes.

### FIELD

The disclosure relates to databases.

### BACKGROUND

One database management system (DBMS) performance driver in the cloud is efficient allocation and management of computing, memory, and storage resources. Recent advancements in distributed DBMS have transitioned from tightly coupled, shared-nothing architectures facing scalability issues and vast data transfers, to disaggregated memory (DM) that decouples computing, and memory. Existing solutions for DM DBMS utilize remote direct memory access (RDMA) with supporting interconnects such as InfiniBand. Although RDMA achieves reliable performance, the high latency (e.g., >2 microseconds) introduced by the interconnects and the absence of cache coherency significantly limit the DM potential. Access to memory via RDMA arrives with protocol conversions and increased read/write amplification leading to high access latency requiring resource caching in local memory for efficient processing. This and the lack of cache coherency demands additional mechanisms to ensure consistency, which degrades performance and scalability, leading to static resource assignment, explicit DBMS state management, and/or resource-based query processing. Static resource assignment may lead to fixed-sized data page buffering and statically allocated memory for other components, resulting in inflexible resource utilization. Explicit DBMS state management, whether centralized, partitioned, or replicated, incurs high update costs and limits scalability. Resource-based query processing for static resource assignments constrains scalability/elasticity, hindering efficient adaptation to varying workloads.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In an aspect, the disclosure provides a method for database management system (DBMS) operations including accessing, by a compute node of the DBMS, one or more objects in state information for a database in a unified memory architecture having multiple memory nodes, wherein the accessing includes using direct memory access (DMA) to access memory in at least a portion of the multiple memory nodes, and performing, by the compute node, one or more query operations for the database based on the state information.

In another aspect, the disclosure provides a system for DBMS operations including one or more memories configured to store instructions, and one or more processors communicatively coupled with the one or more memories. The one or more processors are configured to access one or more objects in state information for a database in a unified memory architecture having multiple memory nodes, where the accessing includes using DMA to access memory in at least a portion of the multiple memory nodes, and perform one or more query operations for the database based on the state information.

In other aspects, the disclosure provides a computer-readable medium comprising code executable by one or more processors for DBMS operations. The code includes code for accessing, by a compute node of the DBMS, one or more objects in state information for a database in a unified memory architecture having multiple memory nodes, where the accessing includes using DMA to access memory in at least a portion of the multiple memory nodes, and performing, by the compute node, one or more query operations for the database based on the state information.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

FIG. 1 illustrates an example of an architecture including multiple compute nodes (CNs) and multiple memory nodes (MNs) coupled via a compute express link (CXL) switch, in accordance with aspects described herein;

FIG. 2 illustrates examples of architectures using a coordinator node approach and a blackboard approach to accessing unified memory, in accordance with aspects described herein;

FIG. 3 illustrates an example of a method for managing database state information in a unified memory architecture, in accordance with aspects described herein;

FIG. 4 presents an example system diagram of various hardware components and other features, for use in accordance with aspects of the present disclosure; and

FIG. 5 is a block diagram of various example system components, for use in accordance with aspects of the present disclosure.

### DETAILED DESCRIPTION

Aspects described herein relate to providing unified buffer management in a database management system (DBMS) using a unified memory architecture, such as compute express link (CXL). For example, CXL can provide a solution that mitigates costs associated with previous approaches to decoupling DBMS compute processes from memory. CXL can enable devices and nodes to interconnect, share, and access memory with memory semantics and byte-addressability using peripheral component interconnect express (PCIe) for the communications infrastructure between nodes. CXL can integrate a cache coherency protocol, facilitating low-latency, high-throughput memory sharing among interconnected nodes. Nodes in CXL can be interconnected via switches providing PCIe bandwidth (e.g., 63 gigabytes per second (GB/s)×16 transfer rate using PCIe 5.0) and/or can offer total switching capacities in the terabytes with memory connected through a memory extension box or directly attached, contributing pooled memory within the CXL network. CXL can also allow for various memory types and/or tiered memory architectures. This can allow integrating, for example, double data rate (DDR)4 memory with fast DDR5 memory, which may reduce costs for customers and providers. CXL can enable the attachment of accelerators (e.g., graphics processing units (GPUs)), allowing shared memory access and workload adaption.

For example, the properties of CXL can enable DM DBMSs to overcome the limitations inherent in RDMA-based solutions. The resulting architecture is no longer a constraint of traditional shared-nothing systems (e.g., systems that share no resources and/or can use a catalog of metadata to manage storage locations of data in the DBMS), as it can combine the scalability of CXL with the benefits of both shared-nothing and shared-memory architectures. Byte-addressability in CXL allows shared memory to be accessed similarly to local main memory, providing a unified system view in a distributed setup. This can facilitate the sharing of arbitrary-sized data and enable a shared buffer manager in CXL to operate on variable-sized objects (and as such can be referred to herein as object-oriented).

In addition, for example, using cooperative memory management can allow for significant enhancements in memory utilization. With this, the buffer can accommodate not only table data but also temporary data, such as intermediate results. Additionally, static memory assignments for other DBMS components, which define the state (e.g., catalog, index, intermediate results), can be dropped and dynamically managed by the buffer manager based on workload demands. This enhancement can accommodate both scan-intensive queries, which require more buffer space for relational data, and processing-intensive queries which demand more buffer space for intermediate results (and this concept can be referred to herein as a unified and object-oriented buffer manager). Dynamically managing memory assignment for the DBMS components can allow the state to be treated as a bufferable and evictable object within the buffer manager, facilitating the development of a stateless DBMS. In cloud environments, for example, statelessness can enhance elasticity by enabling shared buffer memory in CXL to adapt to workload demands. From a cost perspective, statelessness can provide robustness against node failures and can allow workload sharing between computing instances. This capability can support cost-effective spot instances, by which work can continue on other instances as needed.

Distributed DBMSs are mostly shared-nothing architectures, e.g., each node has its main memory, which is typically used for page buffer, catalog, update structures, indexes, and intermediate results. Page buffer can include cache data from storage to reduce input/output (I/O) overhead from files. Files can be organized into multiple pages where a fixed number of these pages are buffered in memory. A buffer manager can enforce eviction strategies for memory utilization by deciding which pages to retain (e.g., hot pages) and which to evict (e.g., cold pages) when the buffer is full. Catalog can store the metadata of tables (e.g., columns, types, keys, and files). Catalog can be a central knowledge part of the DBMS used for parsing, query optimization, and query execution. Additionally, catalog can ensure data integrity and consistency across the database. Update structures can include in-memory delta updates. For example, column stores can be challenging to update due to the internal data organization in columns, which can require accessing multiple pages in storage and restructuring. In-memory delta updates, like positional delta trees (PDTs), are an efficient approach to postponing the immediate effect of updates. These structures temporarily hold updates in deltas before periodically merging into storage, reducing the overhead of accessing the storage at every update. Indexes can provide fast lookup capabilities to access particular data and accelerate queries by reducing the amount of data needed to read. Storing indexes in memory can minimize the latency associated with storage access. Intermediate results can be stored during pipelined query execution and materialized at pipeline breakers, such as shuffles, sorts, and hash table builds in joins or aggregations. Storing the intermediate results in main memory enhances performance, although disk spilling can occur if the results exceed available memory. The intermediate results can be critical for performance as they serve as input for subsequent pipelines, whether executed on the same node, transferred over the network, or materialized to and read from disk.

In accordance with aspects described herein, a database state can include page buffer, catalog, update structures, and/or indexes. While intermediate results are volatile and may only be needed during query execution, the buffer, catalog, update structures, and indexes, summarized as the state of the distributed DBMS, can be maintained between the execution of different queries. Representation of the database state can be managed in various ways including using a distributed/partitioned approach, using replication, or using a centralized approach. For example, in using a distribute/partitioned approach, each node can manage a subset of the global state with local partition information. This approach can enhance scalability as nodes can be easily attached and new partitions added but with higher costs for consistency handling. Further, this approach may use an efficient partitioning scheme. For example, in using replication, each node can manage a copy of the entire database state. This approach can increase fault tolerance and availability as nodes can continue to operate even with node failures. However, maintaining a consistent database state in all copies can decrease performance when processing updates as updates need to be propagated to every node. For example, in using a centralized approach, the entire database state can be managed by a designated node simplifying the state management and ensuring consistency, as the node may be a single source of truth. However, the designated node can be a single point of failure and/or may otherwise become a bottleneck.

In an example, memory management can be provided where limited memory resources may necessitate efficient management of both database state and intermediate results. One solution can be to partition the memory into designated areas for each of the database state and intermediate results, which can enable using a fixed-size buffer to maintain in-memory data pages from storage, using eviction strategies as needed, and/or using a fixed-size area for materializing intermediate query results. A buffer manager can also effectively handle indexes; however, fixed memory partitioning may lack the flexibility to accommodate both scan-heavy workloads, which can use more buffer space, and computation-heavy workloads, which can use more memory for intermediate results. Therefore, cooperative memory management can enhance flexibility, allowing query processing-related buffers to be directly managed by the buffer manager.

In accordance with aspects described herein, a disaggregated DBMS architecture can be provided with one or more of the following capabilities. (1) A disaggregated architecture featuring decoupled compute nodes and memory nodes, where the compute nodes can have local memory for processing and memory nodes can provide shared, pooled memory to the compute nodes, and the compute and memory nodes can be interconnected via CXL or another unified memory architecture. (2) A unified memory management can be provided for managing or otherwise representing the database state (e.g., catalog, deltas, indexes, buffer, etc.) and/or intermediate results with a workload-adaptive eviction strategy. (3) Cache coherent access can be provided via the CXL.mem protocol for shared memory pool access. (4) A stateless DBMS architecture can be provided that enables elastic scaling and stateless query processing. (5) An elastic architecture can be provided that allows attaching accelerators on demand using CXL.

In a disaggregated architecture, for example, computation and memory resources can be decoupled. Computation resources can include compute nodes (CNs) offering computational capabilities with node-local central processing units (CPUs) with caches and limited main memory, while memory resources can include memory nodes (MN) providing extensive memory capacity with limited computational capability. An MN (or multiple MNs) can be seen as a memory extension box, in some examples.

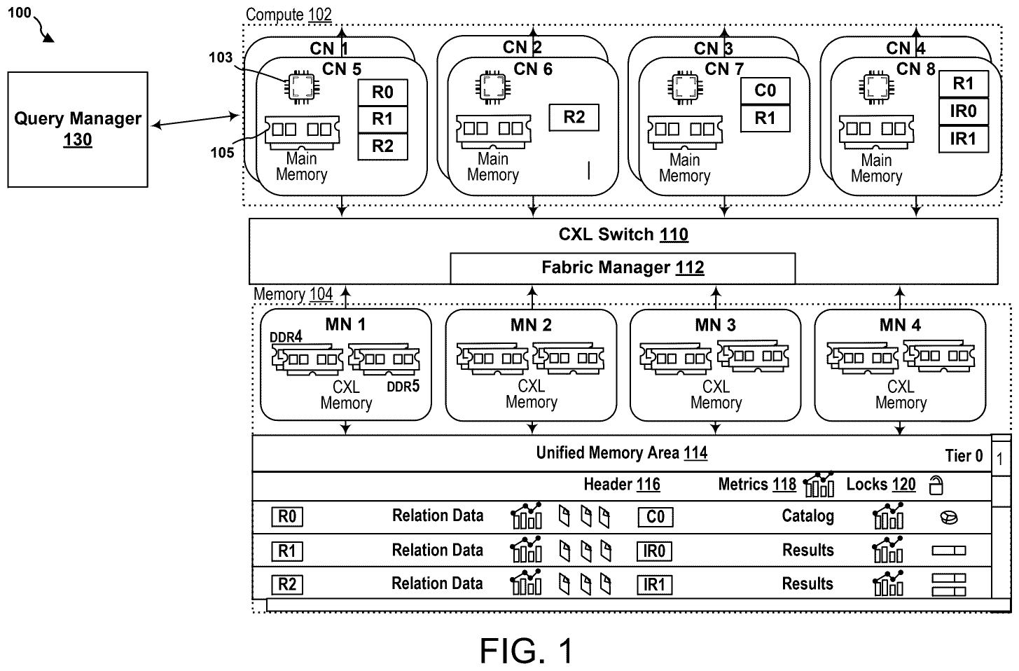

FIG. 1 illustrates an example of an architecture 100 including a compute portion 102 including multiple CNs and a memory portion 104 including multiple MNs coupled via a CXL switch 110, in accordance with aspects described herein. For example, the CNs (e.g., CN1, CN2, CN3, CN4, CN5, CN6, CN7, and/or CN8) may each include one or more processors 103 for providing functionality described herein and a main memory 105 local to the CN for storing instructions for providing the functionality described herein and/or to use as part of the memory pool with the MNs, as described further herein. For example, the MNs (e.g., MN1, MN2, MN3, and/or MN4) can utilize CXL Type 3 memory expanders, where the total memory capacity of the MNs can be pooled and shared among all connected nodes through the global fabric attached memory (GFAM) feature of CXL. The CNs and MNs can be interconnected via a CXL switch 110, which can also serve as an MN, in some examples, when CXL memory is directly attached to the CXL switch 110. The CXL switch 110 can provide a fabric manager 112 (e.g., as an application, a service or other process integrated with an operating system (OS) of the CXL switch 110, etc.) for the general device management of GFAM. For example, management of GFAM can include management of available nodes, capacity, pool setup (interleaving), tiering, etc., to provide shared memory (e.g., unified memory area 114) to the CNs. CXL technology can enable combining various memory types, such as DDR4, DDR5, or persistent memory (PMem), which can be incorporated into the architecture 100. This can enable tiered shared memory based on the types of memory used, as shown for memory types DDR4 and DDR5 for the MNs in architecture 100. In an example, interleaving can be provided within each tier to distribute memory allocation across the available MNs. In contrast to similar architecture via RDMA-enabled interconnects, the architecture described herein may allow nodes to operate on shared data with protocol and/or hardware-incorporated cache coherency solely with memory semantics carried by PCIe. In one example, for persistent storage, the CNs can be connected to cloud storage. The disaggregated memory architecture described herein can have multiple design options, explained in further detail herein.

In one example, the disaggregated memory architecture can be unified, object-oriented, and/or shared buffer. In this example, a distributed, disaggregated architecture can allow the buffer, shared among CNs via CXL, to adapt according to the needs (e.g., processing needs or requirements, parameters, etc.) of the current workload. The byte-addressability of CXL memory can allow it to operate on variable-sized and distinct objects, e.g., instead of fixed-sized pages. With this, the buffer can provide relational data (e.g., R0, R1, R2), catalog information (e.g., C0), update deltas, intermediate results (e.g., IR0, IR1), or whole index data structures in a unified memory area 114. In this regard, for example, architecture 100 can be used to provide, or otherwise used as part of, a stateless DBMS. As such, in an example, the architecture 100 can include a query manager 130 for processing database queries over the DBMS provided by the architecture 100. In this regard, for example, query manager 130 can activate or otherwise utilize one or more CNs to each execute a query engine for processing at least a portion of a database query, determine a number of CNs to activate for the database query, etc. In this regard, query manager 130 can utilize the one or more CNs for processing one or more queries over the stateless DBMS that uses the architecture 100, as described herein The query manager 130 can be an additional CN of the DBMS and/or may include one or more processors and one or more memories for providing or storing instructions for providing the corresponding functionality described herein.

In an example, a shared buffer manager can use more effort than having separate buffer management at each CN, as more variables can be incorporated for an eviction strategy, such as workload, execution time, capacity, or reallocation costs. In this regard, in one example, a coordinator can be a designated CN (or process), which may be referred to as a coordinator CN, commissioned for performing allocation and/or eviction for multiple (e.g., all) CNs. Buffer allocation and eviction can be handled exclusively through the coordinator, in some examples. Other nodes (e.g., other CNs) can communicate their object requests to the coordinator CN, while the coordinator CN can process allocation and/or eviction, and the coordinator CN can communicate the results to the requesting node. The coordinator role can be assigned either statically or dynamically (e.g., by coordination or leader election among nodes, to a node having the highest processing capability or availability over time, etc.). In another example, a blackboard approach can be used with no designated coordinator CN among the computation nodes. In this example, each participating node can manage the shared buffer for allocation and eviction, which may use additional processing resources for synchronization among nodes. Each node can process the buffer using a defined procedure for allocation and eviction. Additionally, in this example, one CN can temporarily handle allocation and eviction for one or more other CNs.

In another example, a disaggregated shared memory architecture can allow for distributed query processing with low overhead, as data shuffling between computation nodes may not be required. Intermediate results (e.g., IR0, IR1), such as tuples, aggregated values, hash tables, etc., can be shared directly via a unified buffer manager, enabling stateless query processing. In an example, work can be distributed effectively among threads on the participating nodes (referred to as worker threads) with elastic scaling. The execution state of worker threads can be shared via unified memory area 114, which may allow use of cheap spot instances as computation nodes. Allocation and eviction in the node-local cache can be orthogonal to this. Access to CXL memory by a CN incurs a higher access latency than the access to usual node-local main memory at the CN. Each switching layer between host and target memory access can increase the latency. CXL protocol can incorporate a cache-coherency mechanism that enables effortless data caching of data originally located in CXL shared memory (e.g., in unified memory area 114) to node-local main memory, while maintaining a coherent view of the data for all other nodes.

In accordance with aspects described herein, unified object-oriented buffer management can be provided. For example, stateless DBMS can use on-demand resource provisioning dependent on current and future workloads. Individual workloads may demand more resources for information about internal structure (catalog) while others may comprise data-intensive joins that use more space (e.g., memory resources) for buffering data. Moreover, costs in cloud environments can play a crucial role and influence resource provisioning. Pooled memory resources can be elastically expanded and shrunk when costs change, which can result in accordingly adapting the buffer space. Computation (e.g., worker threads) can be ruled by reliable instances that finish the workload, or by cheap and unreliable spot instances, that have fewer resources and are subject to deallocation due to resource shortage. Therefore, object-oriented buffer management can be provided in disaggregated memory leveraging CXL with stateless processing. In contrast to traditional buffer management, a unified and object-oriented buffer manager can operate on variable-sized objects. The objects can include distinct data treated by the unified buffer manager as relational data (e.g., R0, R1, R2), which may include multiple pages of memory, catalog information (e.g., C0), update deltas, intermediate results (e.g., IR0, IR1), or index structures, etc. This can allow the allocation of desired data based on workloads to maximize shared memory utilization via CXL. The byte-addressability of CXL can enable memory semantics with high throughput and low latency on a shared memory pool, leveraging a hardware-based cache coherency mechanism with minimal overhead compared to prior RDMA-based solutions that used software-level cache coherency.

Referring to FIG. 1, for example, one or more management headers 116 can be provided (e.g., a management header 116 per tier of memory). For example, nodes that concurrently access unified memory area 114 can use the same access procedures and efficient synchronization with low overhead. In this regard, a general CXL management header 116 can be provided for storing information about current active memory nodes, total capacity, memory for communication and global synchronization primitives, etc. In addition, for example, architecture 100 can include a single unified memory area 114 for each tier where each memory area 114 manages a header 116 that can include the current tier identifier, the number of maximum tier layers, the start offset of the unified buffer in the tier, total capacity, the number of connected nodes, etc., additional space for locks 120 or other synchronization primitives (counter, barriers, write pointer, etc.), and/or the like. The remaining space can be utilized by the unified memory area 114 for sharing and buffering data between CNs. A further header can be used for general management, which can include lock structures for synchronization, the total capacity, current free space, a hash table to identify individual objects (start offset and size), and/or a version counter for synchronization. When new objects are allocated or evicted, the coordinator CN or acting CN (e.g., in blackboard, as described further herein) can increment the version counter in the object header 116. This can indicate that the memory area 114 has been updated, which is an additional mechanism for coherency and can be used as a metric for eviction as the total number of modifications.

The objects referred to here can include generic buffer items shared between CNs. The objects can include pages of relational data (e.g., R0, R1, R2), catalog information (e.g., C0), indexes, update deltas, or intermediate results (e.g., IR0, IR1) from executed queries. These objects can be subject to eviction by the unified buffer manager and can be arbitrarily sized within a multiple of a cache line, to be compliant with the CXL specification for optimal cache coherency. Each object can be stored with a header 116 containing a global identifier for addressing between CNs, size, type (data, catalog, index, etc.), version for tracking changes, internal data structure (number of records and their size), and/or a reference counter to track the number of CN locally caching the object. The reference counter can be used as a metric to identify possible candidate objects for eviction. To further classify hot and cold objects, additional metrics can be stored, such as: an access timestamp, the total number of accesses, the allocation timestamp, the allocation duration, etc. Stored objects can be arbitrarily sized and the application logic can determine the internal structure of the stored data, e.g., by having a concrete scheme for the individual object types.

Each object may be associated with an object index. The architecture 100 can use a hash table, referred to as the object address table (OAT), to index individual buffered objects. The OAT can map global object identifiers to their addresses and tier layers within the buffer. The OAT can be stored in the first tier, which uses the fastest memory type, to enable fast object location via the OAT. Concurrent access can be synchronized using the global lock in locks 120 of the header 116 of the unified memory area 114.

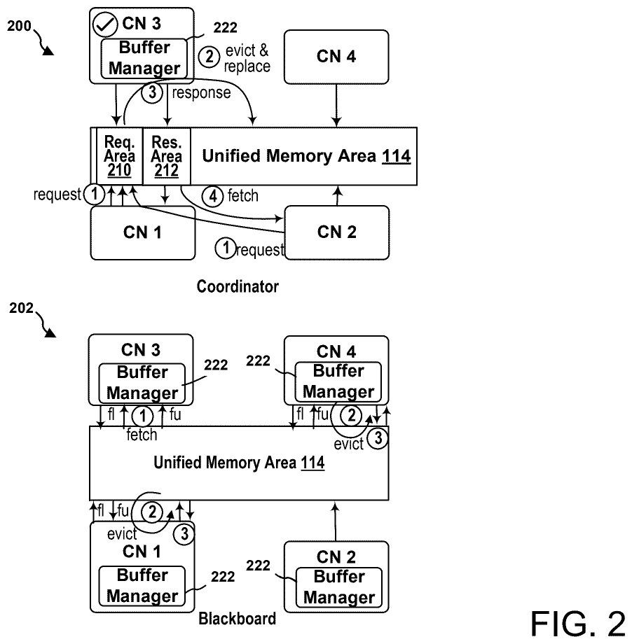

In accordance with aspects described herein, nodes (e.g., CNs) can access the CXL memory using a coordinator CN approach or a blackboard approach. FIG. 2 illustrates an example of an architecture 200 using a coordinator CN approach and architecture 202 using a blackboard approach, in accordance with aspects described herein. In the coordinator CN approach, shown in architecture 200, a process on a coordinator CN (e.g., CN3 in architecture 200) is designated to manage access to the unified memory area 114 by one or more other CNs (e.g., CN1, CN2, CN4) by coordinating allocation requests to the unified memory area 114 (e.g., unified memory area 114) and handling eviction. The coordinator node (CN3) can be statically assigned, such as by selecting the first active or fastest CN, or dynamically assigned, such as through a leader selection algorithm, which can have the advantage of addressing potential leader failures. Other nodes (e.g., CN1, CN2, CN4) can directly access the unified memory area 114 when the desired object is available. Requesting unavailable objects from the unified memory area 114 may be performed through direct communication in a request area 210 in the unified memory area 114 (shown at 1 in architecture 200). For example, a static part of unified memory area 114 can be allocated for communication between nodes and the coordinator (e.g., referred to as the request area 210). The communication area can be structured with a header including area locks for synchronization, and an area write pointer. In this example, nodes can maintain a local read pointer. The remaining area can store one or more messages, which can be of a fixed size and can be structured as a ring buffer for memory reclamation. The one or more messages can include a message identifier (e.g., the current write pointer), an identifier of the requesting node, a task identifier, a request type (object request, allocation), a fix-sized payload to the appropriate request type (object type, size, requesting object identifier), a status flag, etc. Concurrent access to the communication area can be coordinated by locking the area lock.

For example, the coordinator CN (e.g., CN3) can fetch existing objects and/or evict space for new objects using an eviction strategy, shown at 2 in architecture 200. A response can be created for each request, shown at 3 in architecture 200. For completed requests, the coordinator CN can maintain another ring buffer in the unified memory area 114. This can be structured similarly to the request area 210 but can include response messages to the requests (shown as response area 212). A response can be identified with the message identifier and can include information about the requesting object in CXL memory, such as position and size. When handling a request, the coordinator can check if the requested object is available in unified memory area 114. If not, the coordinator can check for available free space in the unified memory area 114 to allocate the object. If there is no free space, the coordinator CN can evict certain objects from the unified memory area 114 to facilitate allocating memory space for the new object. Coordinator CN can utilize an eviction strategy, as described herein, to determine which object(s) to evict. Based on the requested object being stored in unified memory area 114, the requesting node (and/or one or more other nodes) can fetch the requested objects from the response area 212 or otherwise from unified memory area 114, shown at 4 in architecture 200. In another example, inter-node communication can leverage the GIM feature of CXL, where nodes can directly access the main memory of other nodes.

In accordance with aspects described herein, e.g., instead of using a coordinator CN, the CNs can use a blackboard approach to access the CXL memory, as shown in architecture 202. For example, the blackboard approach may maintain no role assignment, which can eliminate the need for coordination between nodes in case of a failure. In this example, each node (or any node) can request use of the unified memory area 114 for storing or retrieving objects and/or can concurrently allocate space for and/or store objects to, unified memory area 114. For example, shared use of the unified memory area 114 in this regard can be achieved with synchronization technologies. Additionally, in some examples using the blackboard approach, each node (or any node) can evict objects from the shared buffer. In such examples, a fine-grained locking mechanism can be provided with one or more constraints. One possible constraint can include fetch constraint (e.g., which can be managed by a fetch lock (fl) or other parameter) that allows only one node to allocate space in the unified memory area 114 at a time. Another possible constraint can include an eviction constraint (e.g., which can be managed by an eviction lock (el) or other parameter) that allows only one node to evict objects from the unified memory area 114 at a time.

In an example, the fetch lock can be acquired when (or based on) an object or space allocation requested by or for a requesting CN. If the requested object is available, the requested object can be directly accessed for or by the requesting CN, and fetch lock can be released, as shown at 1 in architecture 202. When the object is not available, the requesting CN (or other node) can check the unified memory area 114 for available space. If sufficient space is found, the requesting CN (or other node) can directly allocate the space for storing the requested object. If the allocated space is insufficient, the fetch lock is released by or for the requesting CN to allow other nodes to concurrently check for space and/or allocate space for objects. In cases where eviction is used, for example, eviction lock can be acquired by or for the requesting CN to manage the process, as shown at 2 in architecture 202. After eviction is completed, eviction lock can be released by or for the requesting CN, and/or fetch lock can be reacquired to allocate the object in the newly freed space in the unified memory area 114, as shown at 3 in architecture 202. If another node has allocated space in the interim, the eviction and allocation process can be repeated. By globally storing the current allocation size (e.g., size for the new object), other nodes can add their desired allocation size. This can enable nodes to evict space among themselves based on the desired allocations size for other nodes.

In accordance with aspects described herein, to avoid fragmentation in the unified memory area 114, an allocator can determine an appropriate position in the free memory space of unified memory area 114 for storing objects. An additional index can be used to indicate free space and its size. New objects can be intended to fill up the free space first before the end of the unified memory area 114 in a given tier (e.g., tier 0 or 1 in FIG. 1) if it is not filled. In the case of a full memory area, a CN (or coordinator CN) can place objects in the next tier. Stored objects can be evicted, e.g., by a CN or coordinator CN, if there is not enough space available. The allocation can be processed by allocating the header 116 with information regarding the object being stored, such as type, size, version, etc., and then transferring data from local memory at the CN to unified memory area 114. To read an object from unified memory area 114, the node can access the OAT by requesting the OAT along with an object identifier, which can return the position of the object in the unified memory area 114. In an example, a reference counter corresponding to accessing the object can be increased. The object can be directly accessed in CXL (e.g., in the unified memory area 114), or the object can be cached into node-local memory of the CN to decrease the overhead of the higher access latency to CXL memory. When the work on the object is completed or removed from the node-local memory, the reference counter can be decreased. In one example, objects with a reference counter of 0 can be possible candidates for eviction. As the reference counter alone may not distinguish between cold pages and warm pages (e.g., currently unused but generally accessed more frequently or costly to restore pages), a more advanced eviction strategy can be used.

In accordance with aspects described herein, the proposed object-based buffer manager can be a buffer manager 220 provided by a coordinator CN (e.g., CN3) for coordinator approach (e.g., shown in architecture 200), or may be a unified buffer manager 222 provided by each CN for blackboard approach (e.g., shown in architecture 202). In this example, the CNs can cooperatively manage access to the unified memory area 114, modification to objects in the unified memory area 114, and/or the like. The buffer manager 220 or buffer managers 222 can utilize the data or parameters in unified memory area 114, as described above, to manage the contents of the unified memory area 114, to evict objects from and/or allocate space for new objects in the unified memory area 114, etc.

The buffer manager 220 or 222 (e.g., whether provided by a coordinator CN or each CN) can use an eviction strategy that evicts objects considered as “cold” before, or instead of, evicting objects considered as “hot.” For example, an object may be considered, or marked (e.g., using a parameter associated with the object), as “hot” based on a last accessed time being within a threshold time from a current time, or based on having a more recent access time than other objects stored in unified memory area 114, where the remaining objects may be considered, or marked, as “cold.”

In another example, the object-based buffer manager can use a more sophisticated eviction strategy to evict objects from unified memory area 114, which may be based on additional factors, as multiple nodes may be working on a shared resource while processing different workloads. An assignment into hot and cold objects, as with a least recently used (LRU) approach, may not be sufficient, as it does not provide a global and shared classification for all participating CNs. For example, a set of CNs may process a scan-intensive task where catalog information may be unnecessary and thus subject to eviction from the unified memory area 114 by the buffer manager 220 or 222, while other CNs may use the catalog and space for aggregation processing. In this regard, the buffer manager 220 or 222 can use a prioritized list of metrics 118 or other parameters stored for each object to be considered when evicting an object from shared memory. Each of these metrics can use an associated data structure and can capture different information regarding the object, which can enable varied eviction strategies for hot and cold object classification.

In one example, the buffer manager 220 or 222 can use an adaptive, workload-based eviction strategy, which can include prioritizing and/or combining the above-described approaches, data structures, etc.. For example, the buffer manager 220 or 222 can generate the prioritized list by using the appropriate metrics and strategies after each other, or depending on the current workload and its characteristics. Further, when there is no clear hot/cold classification, the buffer manager 220 or 222 can utilize a next metric in the list to determine objects for eviction. The metrics to consider can include: (1) whether objects can be evicted from the tier, (2) an access time (e.g., next access time, which may be estimated or predicted based on a history of access times for the object) and/or frequency for accessing the object, (3) reference count for the object, (4) benefit among nodes, (5) access costs, (6) reallocation costs to reallocate memory for the object or reconstruction costs to reconstruct the object, (7) the object size, and/or similar metrics. In one example, buffer manager 220 or 222 can employ a first strategy that can attempt to evict objects to the next available tier. Access costs to lower tiers can be higher but negligible when compared to reallocation costs. If eviction to a next available tier is not possible, a LRU strategy or epoch-based LRU can be utilized. This strategy can use a global epoch counter and assign it when accessing a certain page. Similar cold pages can share a similar epoch counter and can be treated similarly. Other strategies can include considering the access frequency and reference count for determining objects for eviction. For workload-driven eviction, the remaining strategies can calculate the benefit among the nodes and/or can consider the access cost (latency) to the current tier. In an example, the buffer manager 220 or 222 can use an adaptive strategy that maintains multiple data structures to discover cold objects for eviction. Using such a strategy with the prioritized metrics can allow the buffer manager 220 or 222 to effectively evict objects based on current workload needs.

Different allocation strategies for individual object types may vary in cost. In one example, the buffer manager 220 or 222 can allocate relational data from cloud storage, and can restore catalogs and indexes using log replay. The buffer manager 220 or 222 can recompute intermediate query results, if not persistently stored. The CN can store the allocation costs (on a scale) for the objects. Additionally, the CNs can directly assign the priority of the objects, enabling them to pin an object for a specified duration. The buffer manager 220 or 222 can use such CN-specified information in selecting objects for eviction.

Referring to FIG. 1, in accordance with aspects described herein for the proposed disaggregated architecture shown in FIGS. 1 and/or 2, a query manager 130 can be provided that can communicate with the compute portion 102 of the architecture 100 and/or the associated CNs (e.g., CNs1-8, shown in architectures 100, 200, and/or 202). The query manager 130 can process queries received for the DBMS, which can include allocating CNs to operate in coordinated or blackboard architecture to access the unified memory area 114 to execute one or more queries (e.g., where each CN can include a query engine to execute at least a portion of the one or more queries, at least a portion of at least one of the one or more queries, etc.), as described herein. For example, the query manager 130 can determine an allocation of CNs based on semantics or requirements of the query, cause the CNs to perform the query on data stored in the unified memory area 114, obtain and/or return results of the query to one or more other nodes (e.g., a node requesting the query from the DBMS or query manager 130), and/or the like.

The query manager 130 may be based on operator pipelines, and/or may include a query optimizer, which can make execution decisions to ensure substantially equal work distribution among available CNs. For computation heavy workloads, the query manager 130 can elastically allocate new CNs, as described herein. To reduce data shuffling between individual CNs, the query manager 130 (or buffer manager 220 or 222) can store intermediate results as objects in the unified memory area 114 (e.g., as IR0, IR1), as described herein. Other CNs can access the intermediate results to further process the query or compute results (or further intermediate results) for other queries, which may enhance overall query performance. The decision to store intermediate results can be enforced by the query manager 130 (e.g., or a query optimizer thereof). Intermediate results can include individual tuples, aggregated results, hash tables from joins, etc. In an example, distributed hash join processing can be adapted to CXL shared memory. In this example, CNs can repartition and colocate the build side of a hash join for processing on other nodes or can use a shared hash table in CXL for the build and probe phases of the hash join. In some examples, the buffer manager 220 or 222 can store a query processing state in the unified memory area 114 as an in-memory checkpoint to enable query recovery and continuing after failure, which can be directly adapted. In the event of a node failure during a query, this approach can allow resuming query processing on other CNs or utilizing more affordable, yet potentially less reliable, spot instances. In either case, the resuming node can obtain the query processing state from the unified memory area 114 and continuing processing the query from the state.

In some examples, CXL can enable memory access between various hosts and device types using PCIe-based protocols. This can allow GPUs, field programmable gate arrays (FPGAs), or other hardware accelerators to be attached to disaggregated architectures, treating the shared memory as memory of the hardware accelerator. GPUs can be used for fast analytics and access and provide intermediate results in pooled memory. CNs that directly process these results can significantly reduce data transfers. In a cloud environment, this can allow accelerators to be elastically attached on demand, which can reduce costs for customers and/or cloud providers.

In addition, in some examples, cloud providers aim to enhance performance while minimizing hardware costs and maximizing utilization. Additional hardware costs can be reduced with CXL, as it allows the reuse and mixing of various memory types, such as DDR4 and DDR5. Memory stranding has been identified as a factor contributing to the underutilization of memory resources in cloud environments. This phenomenon occurs when memory is allocated to specific customers but remains unused and unavailable for other customers. CXL can provide a viable solution for memory stranding through efficient fabric management of pooled memory. Memory resources can be elastically scaled by hot-plugging new memory devices or logically assigning memory segments via the fabric manager. The same approach can be applied to scale resources down. This can enable multi-tenancy on pooled memory via CXL. Memory nodes can be shared among clusters (e.g., customers) and/or dynamically adapted to their specific workloads reducing costs for cloud providers and customers.

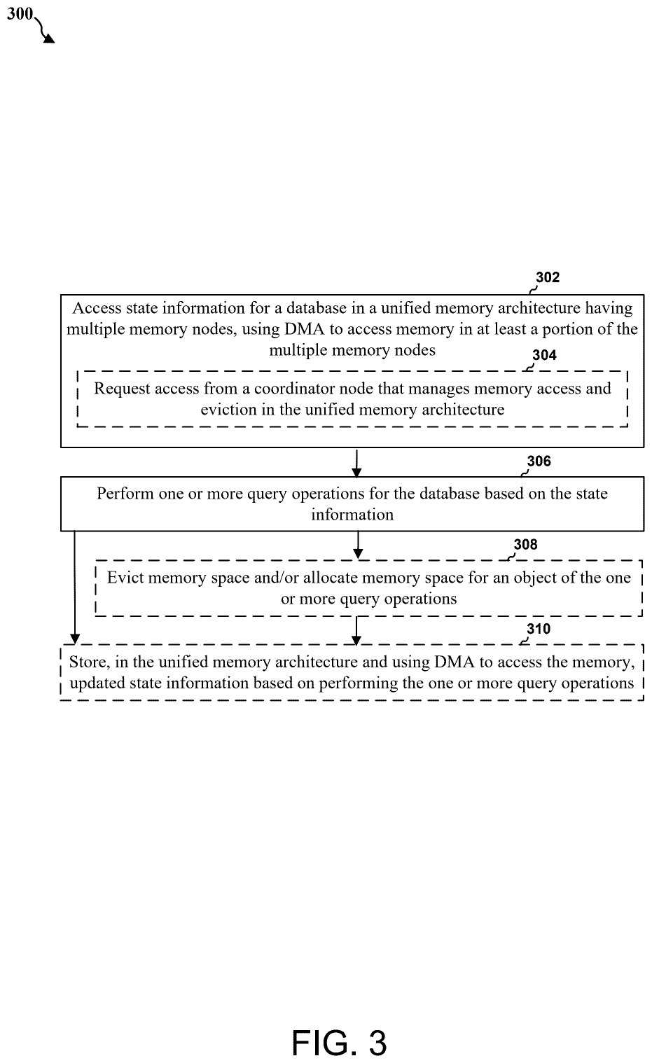

FIG. 3 is a flowchart of an example of a method 300 for managing database state information in a unified memory architecture, in accordance with aspects described herein. The method 300 may be performed by one or more nodes of architectures 100, 200, or 202, such as one or more CNs, buffer manager 220 or 222, etc., using one or more processors 103 to execute corresponding instructions, one or more memories 105 to store instructions or related information, etc.

At block 302, the method 300 may include accessing state information for a database in a unified memory architecture having multiple memory nodes, using DMA to access memory in at least a portion of the multiple memory nodes. For example, a compute node (e.g., using one or more processors 103, one or more memories 105, buffer manager 220 or 222, etc.) can access the state information for the database in the unified memory architecture (e.g., in CXL) having multiple memory nodes, and can use DMA/RDMA to access the memory in at least a portion of the multiple memory nodes. As described, for example, the unified memory architecture, which can include memory nodes connected via CXL, can store the state information for the database in a unified memory area (e.g., unified memory area 114). The state information can include page buffer, catalog, update structures, indexes, and/or intermediate results. Storing the state information in the unified memory area can allow for providing a stateless DBMS where CNs can access state information in the unified memory architecture. In addition, as described in an example, the memory nodes can include memory in other CNs. Moreover, in an example, the unified memory architecture can include multiple tiers of memory, which can include different memory types having different speeds or capacities and associated costs. In an example, different parts of the state information, relational data, etc., may be stored in different tiers.

In one example, accessing the state information at block 302 can optionally include, at block 304, requesting access from a coordinator node that manages access and eviction in the unified memory architecture. For example, the compute node (e.g., using one or more processors 103, one or more memories 105, buffer manager 220 or 222, etc.) can request access of the state information from a coordinator node (e.g., another CN) that manages the memory access and eviction in the unified memory architecture. In another example, e.g., where a blackboard approach is used, the CN itself can directly access the state information from the unified memory architecture (e.g., in unified memory area 114), which may be based on a fetch lock.

At block 306, the method 300 may include performing one or more query operations for the database based on the state information. For example, the compute node (e.g., using one or more processors 103, one or more memories 105, buffer manager 220 or 222, etc.) can perform the one or more query operations for the database based on the state information. In an example, the CN can perform the one or more query operations based on the state information (e.g., using a page buffer, catalog, index, etc. as indicated in the state information). In an example, the CN can retrieve an object from the unified memory area 114 as part of performing the one or more query operations, store an object in the unified memory area 114 (e.g., as a page buffer in cache, an intermediate query result, etc.), and/or the like.

At block 308, the method 300 may optionally include evicting memory space and/or allocating memory space for an object of for the one or more query operations. For example, the compute node (e.g., using one or more processors 103, one or more memories 105, buffer manager 220 or 222, etc.) can evict memory space and/or allocate memory space for an object of the one or more query operations. For example, the CN (or coordinator CN) can evict an object from the unified memory area 114 using an eviction strategy, as described above, when additional space is needed to store the object from the one or more query operations. Following eviction or otherwise, the CN (or coordinator CN) can allocate the memory space for storing the object of the one or more query operations.

At block 310, the method 300 may optionally include storing, in the unified memory architecture and using DMA to access the memory, updated state information based on performing the one or more query operations. For example, the compute node (e.g., using one or more processors 103, one or more memories 105, buffer manager 220 or 222, etc.) can store, in the unified memory architecture and using DMA to access the memory, the updated state information based on performing the one or more query operations. For example, the updated state information can include an object to be stored in the unified memory area 114, such as a page buffer for cached relational data, catalog, update structure, index, intermediate result, etc., as described in various examples herein. In an example, the CN can similarly employ a coordinator node to store the state information or can store the state information itself using a blackboard approach.

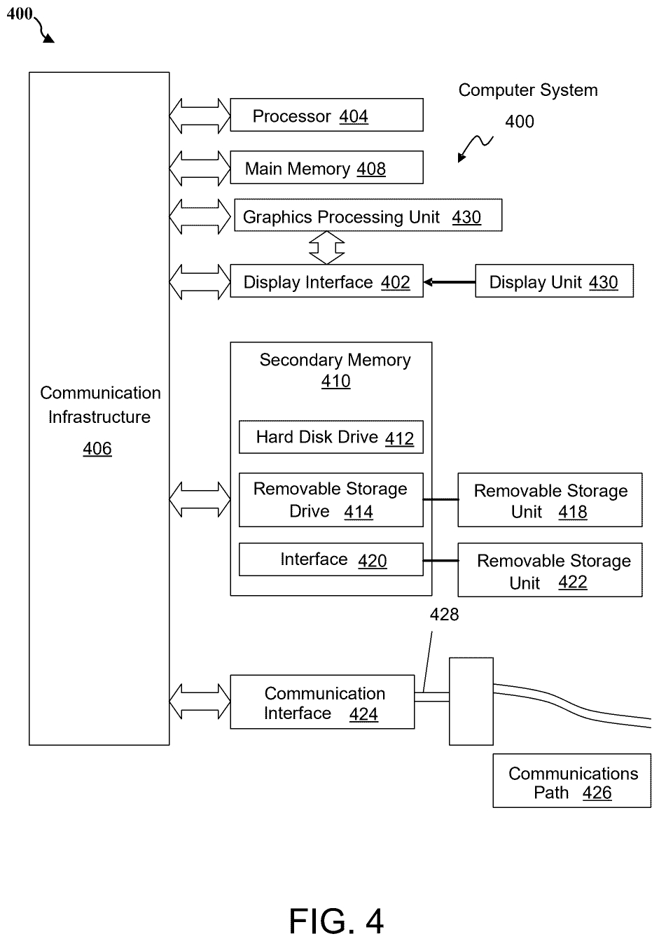

FIG. 4 presents an example system diagram of various hardware components and other features that may be used in accordance with aspects of the present disclosure. Aspects of the present disclosure may be implemented using hardware, software, or a combination thereof and may be implemented in one or more computer systems or other processing systems. In one example variation, aspects of the disclosure are directed toward one or more computer systems capable of carrying out the functionality described herein. An example of such a computer system 400 is shown in FIG. 4.

Computer system 400 includes one or more processors, such as processor 404. The processor 404 is connected to a communication infrastructure 406 (e.g., a communications bus, cross-over bar, or network). Various software aspects are described in terms of this example computer system. After reading this description, it will become apparent to a person skilled in the relevant art(s) how to implement aspects of the disclosure using other computer systems and/or architectures.

Computer system 400 may include a display interface 402 that forwards graphics, text, and other data from the communication infrastructure 406 (or from a frame buffer not shown) for display on a display unit 430. Computer system 400 also includes a main memory 408, preferably random access memory (RAM), and may also include a secondary memory 410. The secondary memory 410 may include nonvolatile memory, for example, a hard disk drive 412, flash memory and/or a removable storage drive 414, representing a floppy disk drive, a magnetic tape drive, an optical disk drive, etc. The removable storage drive 414 reads from and/or writes to a removable storage unit 418 in a well-known manner. Removable storage unit 418, represents a USB memory drive, SD card, floppy disk, magnetic tape, optical disk, etc., which is read by and written to removable storage drive 414. As will be appreciated, the removable storage unit 418 includes a computer usable storage medium having stored therein computer software and/or data.

In alternative aspects, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by communications interface 424. These signals 428 are provided to communications interface 424 via a communications path (e.g., channel) 426. This path 426 carries signals 428 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 414, a hard disk installed in hard disk drive 412, and signals 428. These computer program products provide software to the computer system 400. Aspects of the disclosure are directed to such computer program products.

Computer programs (also referred to as computer control logic) are stored in main memory 408 and/or secondary memory 410. Computer programs may also be received via communications interface 424. Such computer programs, when executed, enable the computer system 400 to perform various features in accordance with aspects of the present disclosure, as discussed herein. In particular, the computer programs, when executed, enable the processor 404 to perform such features. Accordingly, such computer programs represent controllers of the computer system 400.

In variations where aspects of the disclosure are implemented using software, the software may be stored in a computer program product and loaded into computer system 400 using removable storage drive 414, hard disk drive 412, or communications interface 420. The control logic (software), when executed by the processor 404, causes the processor 404 to perform the functions in accordance with aspects of the disclosure as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects of the disclosure are implemented using a combination of both hardware and software.

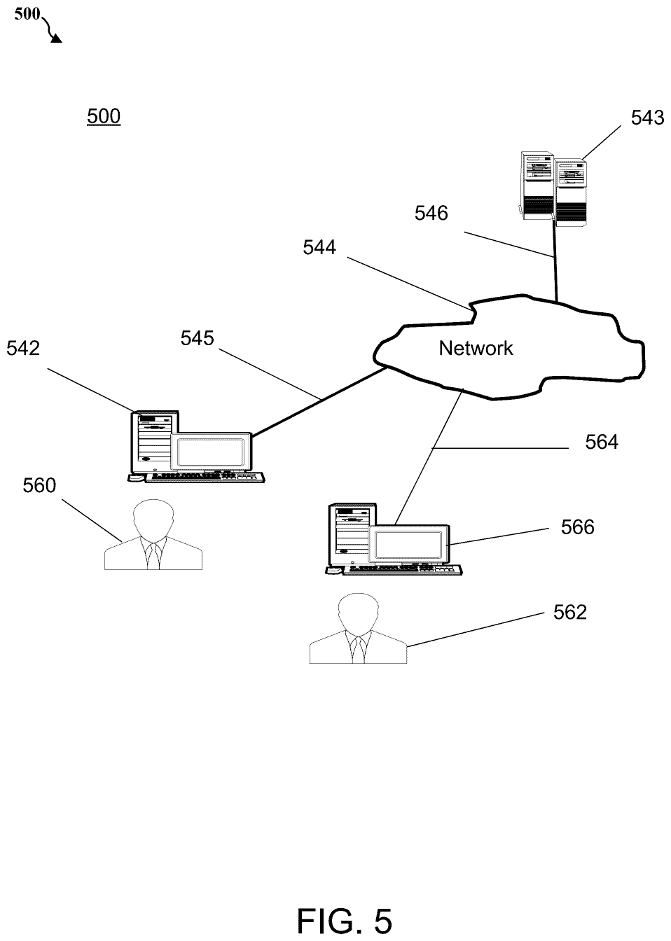

FIG. 5 is a block diagram of various example system components (e.g., on a network) that may be used in accordance with aspects of the present disclosure. The system 500 may include one or more accessors 560, 562 (also referred to interchangeably herein as one or more “users”) and one or more terminals 542, 566. In one aspect, data for use in accordance with aspects of the present disclosure may, for example, be input and/or accessed by accessors 560, 562 via terminals 542, 566, such as personal computers (PCs), minicomputers, mainframe computers, microcomputers, telephonic devices, or wireless devices, such as personal digital assistants (“PDAs”) or a hand-held wireless devices coupled to a server 543, such as a PC, minicomputer, mainframe computer, microcomputer, or other device having a processor and a repository for data and/or connection to a repository for data, via, for example, a network 544, such as the Internet or an intranet, and couplings 545, 546, 564. The couplings 545, 546, 564 include, for example, wired, wireless, or fiber optic links. In another example variation, the method and system in accordance with aspects of the present disclosure operate in a stand-alone environment, such as on a single terminal.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

The foregoing description, for purpose of explanation, has been with reference to specific aspects. However, the illustrative discussions above are not intended to be exhaustive or to limit the disclosure to the precise forms disclosed. Many modifications and variations are possible in view of the above teachings. The aspects were chosen and described in order to best explain the principles of the disclosure and its practical applications, to thereby enable others skilled in the art to best utilize the disclosure and various aspects with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present disclosure, for example, aspects of the innovations herein may be implemented consistent with numerous general purpose or special purpose computing systems or configurations. Various example computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The disclosure may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the disclosure or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosure, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

The following aspects are illustrative only and aspects thereof may be combined with aspects of other embodiments or teaching described herein, without limitation.

Aspect 1 is a method for DBMS operations that includes accessing, by a compute node of the DBMS, one or more objects in state information for a database in CXL memory architecture having multiple memory nodes and multiple compute nodes interconnected, wherein the accessing includes using DMA to access memory in at least a portion of the multiple memory nodes, and performing, by the compute node, one or more query operations for the database based on the state information.

In Aspect 2, the method of Aspect 1 includes where at least a portion of the multiple memory nodes include at least a portion of the multiple compute nodes that perform one or more query operations for the database.

In Aspect 3, the method of any of Aspects 1 or 2 includes where the one or more objects include one or more of a page buffer, a catalog, an update structure, an index, or intermediate query results associated with the database.

In Aspect 4, the method of any of Aspects 1 to 3 includes storing, in the CXL memory architecture and using DMA to access the memory, an updated object of state information based on performing the one or more query operations.

In Aspect 5, the method of any of Aspects 1 to 4 includes where accessing the one or more objects includes requesting access of the one or more objects from a coordinator node that manages memory access to the CXL memory architecture.

In Aspect 6, the method of Aspect 5 include where the coordinator node evicts an object from the CXL memory architecture using an eviction strategy based on multiple parameters, including one or more of object size of the object, estimated next access time of the object, eviction cost for the object, reconstruction cost for the object, or benefit of evicting the object on query execution.

In Aspect 7, the method of any of Aspects 1 to 6 includes where accessing the one or more objects includes cooperatively managing, with the multiple compute nodes, memory access of the CXL memory architecture to access the one or more objects of state information in the CXL memory architecture.

In Aspect 8, the method of Aspect 7 includes evicting an object from the CXL memory architecture using an eviction strategy based on multiple parameters, including one or more of object size of the object, estimated next access time of the object, eviction cost for the object, reconstruction cost for the object, or benefit of evicting the object on query execution.

In Aspect 9, the method of any of Aspects 1 to 8 includes where the CXL memory architecture includes multiple tiers of memory each associated with a type of memory.

Aspect 10 is an apparatus including one or more processors, one or more memories coupled with the one or more processors, and instructions stored in the one or more memories and operable, when executed by the one or more processors, to cause the apparatus to perform any of the methods of Aspects 1 to 9.

Aspect 11 is an apparatus including means for performing any of the methods of Aspects 1 to 9.

Aspect 12 is one or more computer-readable media including code executable by one or more processors, the code including code for performing any of the methods of Aspects 1 to 9.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the disclosure have been specifically described herein, it will be apparent to those skilled in the art to which the disclosure pertains that variations and modifications of the various implementations shown and described herein may be made without departing from the spirit and scope of the disclosure. Accordingly, it is intended that the disclosure be limited only to the extent required by the applicable rules of law.

While the foregoing has been with reference to a particular aspect of the disclosure, it will be appreciated by those skilled in the art that changes in this aspect may be made without departing from the principles and spirit of the disclosure, the scope of which is defined by the appended claims.

What is claimed is:

1. A method for database management system (DBMS) operations, comprising:
accessing, by a compute node of the DBMS, one or more objects in state information for a database in compute express link (CXL) memory architecture having multiple memory nodes and multiple compute nodes interconnected, wherein the accessing includes using direct memory access (DMA) to access memory in at least a portion of the multiple memory nodes; and
performing, by the compute node, one or more query operations for the database based on the state information.

2. The method of claim 1, wherein at least a portion of the multiple memory nodes include at least a portion of the multiple compute nodes that perform one or more query operations for the database.

3. The method of claim 1, wherein the one or more objects include one or more of a page buffer, a catalog, an update structure, an index, or intermediate query results associated with the database.

4. The method of claim 1, further comprising storing, in the CXL memory architecture and using DMA to access the memory, an updated object of state information based on performing the one or more query operations.

5. The method of claim 1, wherein accessing the one or more objects includes requesting access of the one or more objects from a coordinator node that manages memory access to the CXL memory architecture.

6. The method of claim 5, wherein the coordinator node evicts an object from the CXL memory architecture using an eviction strategy based on multiple parameters, including one or more of object size of the object, estimated next access time of the object, eviction cost for the object, reconstruction cost for the object, or benefit of evicting the object on query execution.

7. The method of claim 1, wherein accessing the one or more objects includes cooperatively managing, with the multiple compute nodes, memory access of the CXL memory architecture to access the one or more objects of state information in the CXL memory architecture.

8. The method of claim 7, further comprising evicting an object from the CXL memory architecture using an eviction strategy based on multiple parameters, including one or more of object size of the object, estimated next access time of the object, eviction cost for the object, reconstruction cost for the object, or benefit of evicting the object on query execution.

9. The method of claim 1, wherein the CXL memory architecture includes multiple tiers of memory each associated with a type of memory.

10. A system for database management system (DBMS) operations, comprising:
one or more memories configured to store instructions; and
one or more processors communicatively coupled with the one or more memories, wherein the one or more processors are configured to:
access one or more objects in state information for a database in a compute express link (CXL) memory architecture having multiple memory nodes and multiple compute nodes interconnected, wherein the accessing includes using direct memory access (DMA) to access memory in at least a portion of the multiple memory nodes; and
performing one or more query operations for the database based on the state information.

11. The system of claim 10, wherein at least a portion of the multiple memory nodes include at least a portion of the multiple compute nodes that perform one or more query operations for the database.

12. The system of claim 10, wherein the one or more objects include one or more of a page buffer, a catalog, an update structure, an index, or intermediate query results associated with the database.

13. The system of claim 10, wherein the one or more processors are configured to store, in the CXL memory architecture and using DMA to access the memory, an updated object of state information based on performing the one or more query operations.

14. The system of claim 10, wherein the one or more processors are configured to access the one or more objects at least in part by requesting access of the one or more objects from a coordinator node that manages memory access to the CXL memory architecture.

15. The system of claim 14, wherein the coordinator node evicts an object from the CXL memory architecture using an eviction strategy based on multiple parameters, including one or more of object size of the object, estimated next access time of the object, eviction cost for the object, reconstruction cost for the object, or benefit of evicting the object on query execution.

16. The system of claim 10, wherein the one or more processors are configured to access the one or more objects at least in part by cooperatively managing, with the multiple compute nodes, memory access of the CXL memory architecture to access the one or more objects of state information in the CXL memory architecture.

17. The system of claim 16, wherein the one or more processors are configured to evict an object from the CXL memory architecture using an eviction strategy based on multiple parameters, including one or more of object size of the object, estimated next access time of the object, eviction cost for the object, reconstruction cost for the object, or benefit of evicting the object on query execution.

18. The system of claim 10, wherein the CXL memory architecture includes multiple tiers of memory each associated with a type of memory.

19. A computer-readable medium comprising code executable by one or more processors for DBMS operations, the code comprising code for:
accessing, by a compute node of the DBMS, one or more objects in state information for a database in a compute express link (CXL) memory architecture having multiple memory nodes and multiple compute nodes interconnected, wherein the accessing includes using direct memory access (DMA) to access memory in at least a portion of the multiple memory nodes; and
performing, by the compute node, one or more query operations for the database based on the state information.

20. The computer-readable medium of claim 19, wherein at least a portion of the multiple memory nodes include at least a portion of the multiple compute nodes that perform one or more query operations for the database.
